(19) United States
(12) Patent Application Publication
(10) Pub. No.: US 2026/0355769 A1
(43) Pub. Date: Nov. 12, 2026

(54) SPRAY BOTTLE WITH ON-BOARD MIXING OF LIQUID SOLUTIONS

(71) Applicant: SharkNinja Operating LLC, Needham, MA (US)

(72) Inventors: Devan Schappler, Waltham, MA (US); Haifeng Jiang, Suzhou (CN); Bin Yu, Suzhou (CN); Yonggang Li, Suzhou (CN)

(21) Appl. No.: 19/668,405

(22) Filed: May 5, 2026

Related U.S. Application Data
(63) Continuation of application No. PCT/CN2025/092930, filed on May 6, 2025.

(51) Int. Cl. B05B 11/10

(52) U.S. Cl. CPC B05B 11/1081

(57) ABSTRACT

In general, spray bottles are provided. A system can include a first container configured to contain a first component of a surface cleaning solution, a second container configured to contain a second component of the surface cleaning solution, and a spray head comprising an outlet through which the surface cleaning solution is configured to exit the spray head. The spray head can be configured to releasably couple to the first container, releasably couple to the second container, receive the first component from the first container, receive the second component from the second container, and prevent the first component and the second component from mixing within the spray head to form the surface cleaning solution until a user activates the spray head to open a seal which, in an open position, is configured to allow the first and second components to mix within the spray head.

### CROSS-REFERENCE TO RELATED APPLICATIONS

The present application is a continuation of PCT Application No. PCT/CN2025/092930, filed May 6, 2025, and entitled “SPRAY BOTTLE WITH ON-BOARD MIXING OF LIQUID SOLUTIONS,” and claims the benefit under 35 U.S.C. § 365(c) thereof, which is hereby incorporated by reference in its entirety.

### FIELD

The present disclosure relates generally to spray bottles with on-board mixing of liquid solutions.

### BACKGROUND

Spray bottles are widely used to store and dispense liquid solutions such as liquid cleaning solutions, e.g., disinfectants, sanitizers, degreasers, and detergents. Many existing spray bottles are generally designed to contain and dispense a pre-mixed cleaning solution. These spray bottles typically include a liquid container for containing the cleaning solution and a detachable spray head with a dip tube that can be inserted into the container to create a pathway for the liquid between the container and the spray head outlet.

### SUMMARY

In general, spray bottles and methods of using spray bottles are provided.

In one aspect, a system is provided including a first liquid container, a second liquid container, and a spray head. The spray head can include a first liquid pathway configured to fluidically couple to the first liquid container, a second liquid pathway configured to fluidically couple to the second liquid container, a first piston configured to draw a first liquid configured to be contained in the first liquid container into the first liquid pathway, and a second piston configured to draw a second liquid configured to be contained in the second liquid container into the second liquid pathway.

The spray head can further include an outlet nozzle. The first liquid pathway can be fluidically isolated from the second liquid pathway until an area just upstream of the outlet nozzle. In some embodiments, the first and second pistons are located upstream of the area.

The first piston can be configured to move from a first position to a second position and thereby produce a first pressure change in the first liquid pathway draws the first liquid contained in the first liquid container into the first liquid pathway. In some implementations, a first valve can be arranged in the first liquid pathway downstream of an inlet of the first liquid pathway and can be configured to fluidically couple to the first liquid container. The first valve can be configured to be opened by the first pressure change. In some implementations, a second valve can be arranged in the first liquid pathway downstream of the first valve. The first piston can be configured to move from the second position to the first position and thereby produce a second pressure change in the first liquid pathway. The second valve can be configured to be opened by the second pressure change and the first valve can be configured to be closed by the second pressure change.

The second piston can be configured to move from a first position to a second position and thereby produce a first pressure change in the second liquid pathway that draws the liquid contained in the second liquid container into the second liquid pathway. In some embodiments, a first valve can be arranged in the second liquid pathway downstream of an inlet of the second liquid pathway that is configured to fluidically couple to the second liquid container. The first valve can be configured to be opened by the first pressure change. In some embodiments, a second valve can be arranged in the second liquid pathway downstream of the first valve. The second piston is configured to move from the second position to the first position and thereby produce a second pressure change in the second liquid pathway; the second valve is configured to be opened by the second pressure change; and the first valve is configured to be closed by the second pressure change.

In some implementations, the first liquid can be a first component of a surface cleaning solution and the second liquid can be a second component of the surface cleaning solution. The spray head can include an outlet nozzle, and the first fluid pathway can be fluidically isolated from the second liquid pathway until an area just upstream of the outlet nozzle within which the first and second fluids are configured to mix together. In some implementations, the first liquid container can be configured to be releasably coupled to the spray head and the second liquid container can be configured to be releasably coupled to the spray head independent of the first liquid container.

In another aspect, a system is provided including a first liquid pathway, a second liquid pathway fluidically isolated from the first liquid pathway, a third liquid pathway arranged downstream of the first liquid pathway and the second liquid pathway and configured to selectively fluidically couple to the first liquid pathway and the second liquid pathway, an outlet arranged downstream of the third liquid pathway, and a trigger configured to move from a first position to a second position and thereby simultaneously fluidically couple the third liquid pathway to the first liquid pathway and the second liquid pathway and allow liquid that enters the third liquid pathway from the first and second liquid pathways to move through the outlet. A volume of the third liquid pathway can be less than 0.5 mL.

In some implementations, a valve can be arranged at a junction of the third liquid pathway with the first and second liquid pathways. Movement of the trigger between the first position and the second position can open the valve. The valve can a flap valve or another suitable valve.

The first liquid pathway can be configured to fluidically couple to a first liquid container and the second liquid pathway can be configured to fluidically couple to a second liquid container. The first liquid container can be configured to contain a first liquid and the second liquid container can be configured to contain a second liquid. The system can include first and second liquid containers. The first liquid container can be configured to be releasably coupled to the spray head and the second liquid container can be configured to be releasably coupled to the spray head independent of the first liquid container.

With the third liquid pathway fluidically coupled to the first and second liquid pathways, the first liquid can be configured to enter the third liquid pathway from the first liquid pathway and the second liquid is configured to enter the third liquid pathway from the second liquid pathway to form a mixture of the first and second fluids in the third liquid pathway. The mixture of the first liquid and the second liquid can be unstable.

The system can include a first piston configured to draw the first liquid into the first liquid pathway and a second piston configured to draw second into the second liquid pathway. The first piston and the second piston can be operatively mechanically coupled to the trigger.

In some embodiments, the first liquid container is configured to contain a first liquid that is a first component of a surface cleaning solution and the second liquid container is configured to contain a second liquid that is a second component of the surface cleaning solution. The first liquid pathway can be fluidically isolated from the second liquid pathway until an area just upstream of the outlet within which the first and second fluids are configured to mix together.

In yet another aspect, a system is provided including a liquid inlet, a first valve arranged downstream of the liquid inlet, a second valve arranged downstream of the first valve, a liquid outlet, and at least one piston. The at least one piston can be configured to move from a first position to a second position and thereby produce a first pressure change that opens the first valve. Additionally, the at least one piston can be configured to move from the second position to the first position and thereby produce a second pressure change that closes the first valve, opens the second valve, and drives liquid through the liquid outlet.

The first valve can be in a first liquid pathway downstream of the outlet and the second valve can be in a second liquid pathway downstream of the outlet and fluidically isolated from the first liquid pathway. A first liquid container can be configured to fluidically couple to the first liquid pathway and a second liquid container can be configured to fluidically couple to the second liquid pathway. The first liquid container can be configured to contain a first liquid that is a first component of a surface cleaning solution and the second liquid container can be configured to contain a second liquid that is a second component of the surface cleaning solution. The first liquid pathway can be fluidically isolated from the second liquid pathway until an area just upstream of the outlet within which the first and second fluids are configured to mix together.

In some implementations, a spray head can include the first valve, the second valve, the outlet, and the at least one piston. The first liquid container can be configured to be releasably coupled to the spray head and the second liquid container can be configured to be releasably coupled to the spray head independent of the first liquid container. A third liquid pathway can be arranged downstream of the first liquid pathway and the second liquid pathway and configured to selectively fluidically couple to the first liquid pathway and the second liquid pathway. The third liquid pathway can be configured to be fluidically coupled to the first and second liquid pathways by the second pressure change.

In some embodiments, at least one of the first valve and the second valve is a ball valve, spring-loaded valve, or another type of valve. The system can further include a trigger configured to move the at least one piston between the first position and the second position. The at least one piston can include at least one spring configured to bias the at least one piston to the first position.

In yet another aspect, a system is provided including a fluid container. The fluid container can include an opening and a tube. The tube can include a first end arranged in the opening, a second end arranged in an interior volume of the fluid container, and a medial portion extending between the first end and the second end. The system can further include a spray head including a first fluid pathway configured to fluidically couple to the first end of the tube to receive a first liquid from the fluid container, and a second fluid pathway configured to fluidically couple to a portion of the opening surrounding the first end of the tube to receive a first gas from the fluid container. The gas can a byproduct of a chemical reaction involving the first liquid.

In some implementations, a valve can be adjacent the outlet. The valve can be configured to open when a fluid pressure of the first gas exceeds a threshold pressure value. The valve can be a duckbill valve or another suitable valve.

The medial portion of the tube can include a first portion and a second portion oriented at an angle relative to the first portion. The angle can be greater than 90° and less than 180°, for example approximately 158°. The second portion can be longer than the first portion. The second end of the tube can be arranged in a bottom portion of the interior volume, for example, in a corner portion of the interior volume defined by a bottom surface of the fluid container and a sidewall of the fluid container.

The fluid container can be configured to be releasably coupled to the spray head. The first liquid can be a liquid for cleaning a surface.

In some embodiments, the system can further include a second fluid container. The second fluid container can include a second opening and a second tube including a third end arranged in the second opening, a fourth end arranged in an interior volume of the second fluid container, and a medial portion extending between the third end and the fourth end. The spray head can further include a third fluid pathway configured to fluidically couple to the third end of the second tube to receive a second liquid from the second fluid container, a fourth fluid pathway configured to fluidically couple to a portion of the second opening surrounding the third end of the second tube to receive a second gas from the second fluid container.

In yet another aspect, a system is provided including a first container configured to contain a first component of a surface cleaning solution, a second container configured to contain a second component of the surface cleaning solution, and a spray head including an outlet through which the surface cleaning solution is configured to exit the spray head. The spray head can be configured to releasably couple to the first container, releasably couple to the second container, receive the first component from the first container, and receive the second component from the second container. The spray head can be configured to prevent the first component and the second component from mixing within the spray head to form the surface cleaning solution until a user activates the spray head to open a first seal which, in an open position, can be configured to allow the first and second components to mix within the spray head.

The spray head can further include a second seal upstream of the first seal and in a first liquid pathway associated with the first liquid container, a third seal upstream of the first seal and in a second liquid pathway associated with the second liquid container, a fourth seal upstream of the second seal and in the first liquid pathway associated with the first liquid container, and a fifth seal upstream of the third seal and in the second liquid pathway associated with the second liquid container. The user activating the spray head can cause the second and third seals to open and cause the first seal to open after the second and third seals open. Deactivation of the spray head by the user can be configured to cause the fourth and fifth seals to open after the first seal opens.

The spray head can include a trigger configured to be pulled by the user to activate the spray head and to be released by the user to deactivate the spray head. The first seal in a closed position can be configured to prevent the first component and the second component from mixing within the spray head. The spray head can further include a trigger configured to be pulled by the user to activate the spray head.

In yet another aspect, a system is provided including a spray head including an outlet through which a surface cleaning solution is configured to exit the spray head. The spray head can be configured to receive a first component of the surface cleaning solution from a first container and receive a second component of the surface cleaning solution from a second container. The spray head can be further configured to prevent mixture of the first and second components within the spray head until after the first component passes through a first one-way valve upstream of the outlet and the second component passes through a second one-way valve upstream of the outlet.

The spray head can include a mixing chamber upstream of the outlet and downstream of the first and second one-way valves. In some implementations, the spray head can include a first seal upstream of the outlet, downstream of the first and second one-way valves, and downstream of the mixing chamber. The first seal in an open position can be configured to allow the first and second components to enter the mixing chamber. The first seal in a closed position can be configured to prevent the first and second components from entering the mixing chamber. In some implementations, the spray head can further include a second seal upstream of the first one-way valve. The second seal in an open position can be configured to allow the first component to flow toward the first one-way valve. The second seal in a closed position can be configured to prevent the first component from flowing toward the first one-way valve. In some implementations, the spray head can further include a third seal upstream of the first one-way valve. The third seal in an open position can be configured to allow the second component to flow toward the second one-way valve. The third seal in a closed position can be configured to prevent the second component from flowing toward the second one-way valve.

In some embodiments, the system can include the first and second containers. The spray head can be configured to releasably couple to the first and second containers. The first container can have a first breathing valve configured to allow venting of the first container with the second seal in the closed position. The first breathing valve can be a duckbill valve, a vented liner, or any other suitable breathing valve or seal.

In yet another aspect, a system is provided including a first container configured to contain a first component of a surface cleaning solution, a second container configured to contain a second component of the surface cleaning solution, and a spray head including an outlet through which the surface cleaning solution is configured to exit the spray head. The spray head can be configured to receive the first component of the surface cleaning solution from the first container, receive the second component of the surface cleaning solution from the second container, and generate a pressure change configured to simultaneously combine the first and second components to form the surface cleaning solution within the spray head and drive the surface cleaning solution through the outlet.

In some embodiments, the spray head can include a first region upstream of the outlet and a second region upstream of the outlet. The spray head can be configured to receive the first component of the surface cleaning solution in the first region and receive the second component of the surface cleaning solution in the second region. In some implementations, the spray head can further include a third region downstream of the first and second regions and upstream of the outlet. The third region can be configured to selectively fluidically couple to the first and second regions. In some embodiments, the pressure change can be configured to fluidically couple the third region to the first and second regions. The spray head can further include a valve arranged at a junction of the third region and the first and second regions, wherein the pressure change opens the valve. The spray head can further include at least one piston configured move from a first position to a second position to generate the pressure change.

In yet another aspect, a method including use of any of the above-described systems is provided.

The details of one or more variations of the subject matter described herein are set forth in the accompanying drawings and the detailed description. Other features and advantages of the subject matter described herein will be apparent from the description, the drawings, and the claims.

### BRIEF DESCRIPTION OF THE FIGURES

The described subject matter will be more readily understood from the following detailed description in conjunction with the accompanying drawings, in which:

FIG. 1 shows a block diagram of a spray bottle system, according to some embodiments;

FIG. 2 shows a perspective view of one implementation of a spray bottle;

FIG. 3A shows a perspective view of a liquid container of the spray bottle shown in FIG. 2;

FIG. 3B shows a second perspective view of the liquid container shown in FIG. 3A;

FIG. 3C shows a cross-sectional side view of the liquid container shown in FIG. 3A;

FIG. 3D shows a top perspective view of a plug of the liquid container shown in FIG. 3A;

FIG. 4 shows a bottom perspective view of a spray head of the spray bottle shown in FIG. 2;

FIG. 5A shows a cross-sectional bottom-up view of the spray head of the spray bottle shown in FIG. 2;

FIG. 5B shows a cross-sectional side partial view of the spray head of the spray bottle shown in FIG. 2;

FIG. 6 shows a cross-sectional rear view of the spray head of the spray bottle shown in FIG. 2;

FIG. 7 shows another cross-sectional side partial view of the spray bottle shown in FIG. 2;

FIG. 8 shows a top-down cross-sectional view of the spray head of the spray bottle shown in FIG. 2;

FIG. 9 shows one implementation of a method of operating a spray bottle;

FIG. 10 shows another implementation of a method of operating a spray bottle; and

FIG. 11 shows yet another implementation of a method of operating a spray bottle.

### DETAILED DESCRIPTION

Certain embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices, systems, and methods specifically described herein and illustrated in the accompanying drawings are non-limiting embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Many existing spray bottles are, in general, designed to contain and dispense pre-mixed cleaning solutions. As a result, these spray bottles tend to be incompatible with unstable cleaning solutions that degrade in potency or effectiveness over time. Some spray bottles attempt to mitigate such degradation by storing components of an unstable cleaning solution in separate liquid containers. Such a spray bottle may be configured to store a pre-mixture of a portion of each solution component such that, if the spray bottle goes unused for an extended period, only the pre-mixed solution degrades, while the individual solution components remain usable. These designs, however, can still result in significant volumes of cleaning solution being wasted.

Disclosed herein is a spray bottle with a spray head that can prevent mixing of a cleaning solution until the cleaning solution is dispensed from the spray bottle, thereby ensuring that the dispensed solution is potent and effective. In an exemplary implementation,. the spray bottle includes a plurality of replaceable liquid containers, e.g., two replaceable liquid containers, etc., each of which can contain a liquid component of a cleaning solution. Each liquid container (also referred to herein as a “container”) can have an integrated dip tube that enables the container to be fully emptied by the spray head, thereby substantially reducing liquid component waste. The spray head, which can releasably connect to the plurality of liquid containers, can includes an arrangement of valves and pistons that can prevent premature mixing of the solution liquid components and/or can relieve pressure buildup in the liquid containers that can lead to issues such as dripping.

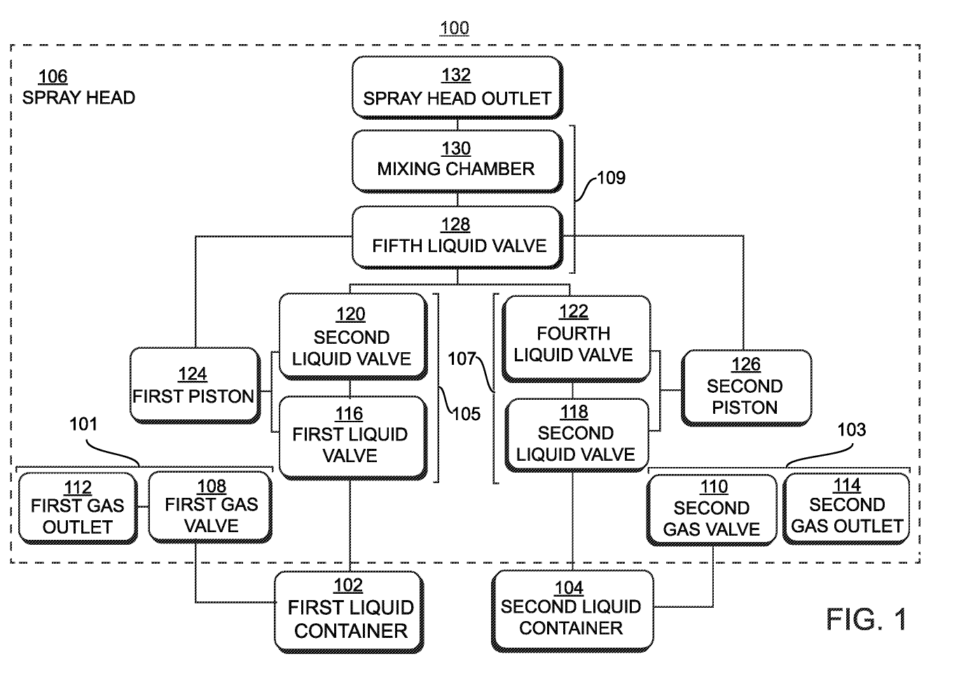

FIG. 1 illustrates an exemplary spray bottle system. In the illustrated implementation, the system 100 includes a first liquid container 102, a second liquid container 104, and a spray head 106. The spray head 106 can be configured to fluidically couple to the first and second liquid containers 102, 104. As shown, the spray head 106 can include a first gas pathway 101, a second gas pathway 103, a first liquid pathway 105, a first piston 124, a second liquid pathway 107, a second piston 126, a third liquid pathway 109, and an outlet (also referred to herein as a “spray head outlet”) 132.

In some implementations the spray head 106 can be configured to fluidically couple to the first and second liquid containers 102, 104 simultaneously, which may be convenient for a user of the spray bottle. In some implementations, the first and second liquid containers 102, 104 can be held or otherwise bound together, e.g., by shrink wrap, a rubber or plastic band, and/or the like, to facilitate simultaneous fluidic coupling of the liquid containers 102, 104 to the spray head 106. In other implementations the spray head 106 can be configured to fluidically couple to the first and second liquid containers 102, 104 one at a time, which may allow for individual replacement of each of the first and second liquid containers 102, 104 that may be more cost effective for users of the spray bottle than simultaneous replacement of the first and second liquid containers 102, 104.

The first liquid container 102 can be configured to contain a first liquid, and the second liquid container 104 can be configured to contain a second liquid. The first and second liquids can be configured to mix to form a liquid solution expellable from the spray bottle. In an exemplary implementation the solution is a cleaning solution for cleaning a surface, e.g., a floor, a tabletop, upholstery, etc. In such an implementation each of the first liquid and the second liquid can be any suitable liquid cleaning agent or component of a liquid cleaning solution, for example, a liquid detergent, a liquid stain remover, a bleach, a degreaser, a disinfectant, a sanitizer, an enzymatic cleaner, an acid, a base, a liquid soap, an alcohol, or a descaling liquid.

In some implementations, the first liquid contained in the first liquid container 102 is a first component of a liquid cleaning solution and the second liquid contained in the second liquid container 104 is a second component of the liquid cleaning solution. In some implementations, the first liquid has a lower pH (e.g., a pH of 5, or another pH value less than 7) and the second liquid has a higher pH (e.g., a pH of 9, or another pH value greater than 7). For example, the first liquid can be an acidic peroxide-based cleaning liquid (e.g., acidic hydrogen peroxide) and the second liquid can be a basic chemical. When mixed together, the first liquid and the second liquid may continue chemically reacting and, as a result, the liquid cleaning solution that is produced by mixing the first and second liquids may be an unstable solution with chemical properties that change over time. For example, the liquid cleaning solution may have one or more chemical properties which, over time, are rendered inert or neutral.

In some implementations, the first liquid can be a chemical that spontaneously reacts or degrades while contained in the first liquid container 102 to produce a gas inside of the first liquid container 102. Similarly, in some implementations, the second liquid can be a chemical that spontaneously reacts or degrades while contained in the second liquid container 104 to produce a gas inside of the second liquid container 104.

The first and second gas pathways 101, 103 can be configured to, with the first and second liquid containers 102, 104 coupled to the spray head 106, prevent excess pressure buildup within the first and second liquid containers 102, 104 by enabling gases produced inside of the first and second liquid containers 102, 104 to be released from the liquid containers 102, 104.

The first gas pathway 101 can be configured to fluidically couple to receive and vent gas from the first liquid container 102 with the first liquid container 102 coupled to the spray head 106. Similarly, the second gas pathway 103 can be configured to fluidically couple to receive and vent gas from the second liquid container 104 with the second liquid container 104 coupled to the spray head 106. As shown in FIG. 1, the first gas pathway 101 can include a first gas outlet 112 and a first gas valve 108 that is fluidically coupled to the first gas outlet 112, and the second gas pathway 103 can include a second gas outlet 114 and a second gas valve 110 that is fluidically coupled to the second gas outlet 114. The first gas valve 108 can be a one-way valve that is configured to open to enable gas flow from the first liquid container 102 to the first gas outlet 112 while preventing backflow of gas into the first liquid container 102. Likewise, the second gas valve 110 can be a one-way valve that is configured to open to enable gas flow from the second liquid container 104 to the second gas outlet 114 while preventing backflow of gas into the second liquid container 104.

The first and second gas valves 108, 110 can be implemented using any suitable valve, for example vented liners, umbrella valves, or duckbill valves. In some embodiments, the first and second gas valves 108, 110 can be breathable valves. In some embodiments, the first gas valve 108 can be implemented using a different type of valve than the type used to implement the second gas valve 110.

While in the illustrated implementation the spray head 106 includes two gas pathways, each of which includes a single gas valve and a single gas outlet, in other implementations a spray head can include fewer than two gas pathways or can include a gas pathway with a fewer or more than two gas valves. For example, if only the first liquid container 102 is configured to contain a liquid that reacts to produce a gas inside the container 102, the spray head 106 may include only the first gas pathway 101. If neither of the liquid containers 102, 104 is configured to contain a liquid that reacts to produce a gas, the spray head 106 may include no dedicated gas pathways. In other words, in implementations in which the first and second liquids do not produce gas within their respective liquid containers 102, 104, the first and second gas pathways 101, 103 may be omitted.

The first liquid pathway 105 can be configured to fluidically couple to the first liquid container 102 and be arranged downstream of the first liquid container 102, and second liquid pathway 107 can be configured to fluidically couple to the second liquid container 104 and be arranged downstream of the second liquid container 104. A third liquid pathway 109 can be arranged downstream of the first and second liquid pathways 105, 107. To mitigate premature mixing of the first liquid and the second liquid, the first liquid pathway 105 and the second liquid pathway 107 can be fluidically isolated from one another such that liquid received from the first container 102 in the first liquid pathway 105 does not mix in the spray head 106 with liquid received from the second container 104 in the second liquid pathway 107 until the first and second liquid pathways 105, 107 join at the third liquid pathway 109 in the spray head 106.

The first liquid pathway 105 can include a first liquid valve 116 and a second liquid valve 120. The first and second liquid valves 116, 120 can be any suitable one-way valves. Example valves include (but are not limited to) ball valves (e.g., metal ball valves, rubber ball valves, glass ball valves, etc.) spring-loaded flap valves, duckbill valves, umbrella valves, or the like.

The first liquid valve 116 can be a one-way valve configured to open to enable the first liquid to flow from the first container 102 and into a region of the first liquid pathway 105 between the first and second liquid valves 116, 120 and to prevent backflow of the first liquid from the region of the first liquid pathway 105 between the first and second liquid valves 116, 120 into the first container 102. The second liquid valve 120 can be a one-way valve configured to enable the first liquid to flow from the region of the first liquid pathway 105 between the first and second liquid valves 116, 120 and into a region of the first liquid pathway 105 just upstream of the third liquid pathway 109 and to prevent backflow of the first liquid from the region just upstream of the third liquid pathway 109 into the region between the first and second liquid valves 116, 120.

The first and second liquid valves 116, 120 can be operatively coupled to the first piston 124. The first piston 124 can be configured to move from a first position to a second position and thereby produce a first pressure change in the first liquid pathway 105 that causes the first liquid valve 116 to open. With the spray head 106 fluidically coupled to the first liquid container 102 and the first piston 124 is moved from the first position to the second position, the first liquid that is contained in the first liquid container 102 can be drawn, due to the first pressure change, into the first liquid pathway 105 and through the open first liquid valve 116. The first piston 124 can be configured to thereafter move from the second position back to the first position and thereby produce a second pressure change in the first liquid pathway 105 that causes the first liquid valve 116 to open and causes the second liquid valve 120 to close. First liquid that is contained in the region of the first liquid pathway 105 between the first liquid valve 116 and the second liquid valve 120 can be drawn, due to the second pressure change, through the second liquid valve 120 and into the region of the first liquid pathway 105 just upstream of the third liquid pathway 109.

The second liquid pathway 107 can include a third liquid valve 118 and a fourth liquid valve 122. The third and fourth liquid valves 118, 122 can be any suitable one-way valves. Example valves include (but are not limited to) ball valves (e.g., metal ball valves, rubber ball valves, glass ball valves, etc.) spring-loaded flap valves, duckbill valves, umbrella valves, or the like.

The third liquid valve 118 can be a one-way valve configured to open to enable the second liquid to flow from the second container 104 and into a region of the second liquid pathway 107 between the third and fourth liquid valves 118, 122 and to prevent backflow of the second liquid from the region between the third and fourth liquid valves 118, 122 into the second container 104. The fourth liquid valve 122 can be a one-way valve configured to enable the second liquid to flow from the region of the second liquid pathway 107 between the third and fourth liquid valves 118, 122 and into a region of the second liquid pathway 107 just upstream of the third liquid pathway 109 and to prevent backflow of the second liquid from the region just upstream of the third liquid pathway 109 into the region between the third and fourth liquid valves 118, 122.

The third and fourth liquid valves 118, 122 can be operatively coupled to the second piston 126. The second piston 126 can be configured to move from a first position to a second position and thereby produce a first pressure change in the second liquid pathway 107 that causes the third liquid valve 118 to open. With the spray head 106 fluidically coupled to the second liquid container 104 and the second piston 126 is moved from the first position to the second position, the second liquid that is contained in the second liquid container 104 can be drawn, due to the first pressure change, into the second liquid pathway 107 and through the open third liquid valve 118. The second piston 126 can be configured to thereafter move from the second position back to the first position and thereby produce a second pressure change in the second liquid pathway 107 that causes the third liquid valve 118 to close and causes the fourth liquid valve 122 to open. Second liquid that is contained in the region of the second liquid pathway 107 between the third liquid valve 118 and the fourth liquid valve 122 can be drawn, due to the second pressure change, through the fourth liquid valve 122 and into the region of the second liquid pathway 107 just upstream of the third liquid pathway 109.

In some implementations, the first piston 124 and the second piston 126 can be configured to simultaneously move from their respective first positions to their respective second positions and to simultaneously move from their respective second positions to their respective first positions. For example, the first piston 124 and the second piston 126 can be operatively coupled to a trigger or other manual control of the spray head 106 that is configured to simultaneously move the first piston 124 and the second piston 126.

In some implementations, the volume of the first liquid that is drawn into the spray head 106 from the first liquid container 102 when the first piston 124 is moved from its first position to its second position can be approximately equal to the volume of the second liquid that is drawn into the spray head 106 from the second liquid container 104 when the second piston 126 is moved from its first position to its second position. In other words, the first and second pistons 124, 126 can enable an approximately 1:1 ratio of the first and second liquids to be drawn into the spray 106. As a result, the first liquid container 102 and the second liquid container 104 can be drained of liquid at the same rate, which can allow the first and second liquid containers 102, 104 to be replaced simultaneously, if a total volume of the first liquid container 102 is approximately equal to a total volume of the second liquid container 104.

The third liquid pathway 109 can include a fifth liquid valve 128 and a mixing chamber 130 arranged downstream of the fifth liquid valve 128. The fifth liquid valve 128 can be configured to enable first liquid contained in the region of the first liquid pathway 105 just upstream of the third liquid pathway 109 and second liquid contained in the region of the second liquid pathway 107 just upstream of the third liquid pathway 109 to flow into the mixing chamber 130. The mixing chamber 130 can provide a volumetric region in which the first liquid received through the first fluid pathway 105 and the second liquid received through the second fluid pathway 107 can mix.

The fifth liquid valve 128 can be any suitable valve. In some implementations, the fifth liquid valve 128 is a flap valve.

The fifth liquid valve 128 can be configured to be opened by the combination of the first pressure change produced in the first liquid pathway 105 in response to the first piston 124 moving from its first position to its second position and the first pressure change produced in the second liquid pathway 107 in response to the second piston 126 moving from its first position to its second position. In other words, the fifth liquid valve 128 can be configured to selectively fluidically couple the third liquid pathway 109 to the first fluid pathway 105 and the second fluid pathway 107.

The size of the mixing chamber 130 can be such that the volume of the mixture of the first and second liquids contained in the spray head 106 at any given time is below a threshold volume. Maintaining the volume of the mixture below the threshold volume can mitigate dripping or leaking of the mixture from the mixing chamber 130. In some implementations, the volume of the mixing chamber 130 is less than approximately 2 mL, less than approximately 1.5 mL, less than approximately 1 mL, less than approximately 0.8 mL, less than approximately 0.5 mL, less than approximately 0.3 mL, or less than approximately 0.1 mL. In some implementations, the volume of the mixing chamber 130 is between approximately 0.1 mL and 0.5 mL, for example approximately 0.15 mL, approximately 0.2 mL, approximately 0.25 mL, approximately 0.3 mL, approximately 0.35 mL, approximately 0.4 mL, or approximately 0.45 mL. A person skilled in the art will appreciate that a volume (or other variable) may not be precisely at a value but nevertheless be considered to be approximately or substantially at that value for any of a variety of reasons, such as manufacturing tolerances and sensitivity of measurement equipment.

The third liquid pathway 109 can be arranged just upstream of an outlet 132 of the spray head 106. The outlet 132 can be an opening, e.g., a nozzle, through which the mixed solution can be sprayed, for example an adjustable spray nozzle configured to produce multiple spray patterns selectable by a user. In some implementations, when the third fluid pathway 109 is fluidically coupled to the first and second fluid pathways 105, 107 (e.g., when the fifth liquid valve 128 is open), the spray head 106 can be configured to allow any liquid contained in the mixing chamber 130 to move through the outlet 132. The spray head 106 may therefore significantly limit the amount of time between the mixing of the first and second liquids in the mixing chamber 130 and the dispensing of the mixture through the outlet 132, thus reducing the amount by which the mixture degrades, thereby ensuring that the mixed solution has the desired properties when it is dispensed, e.g., maximum cleaning effectiveness for a cleaning solution.

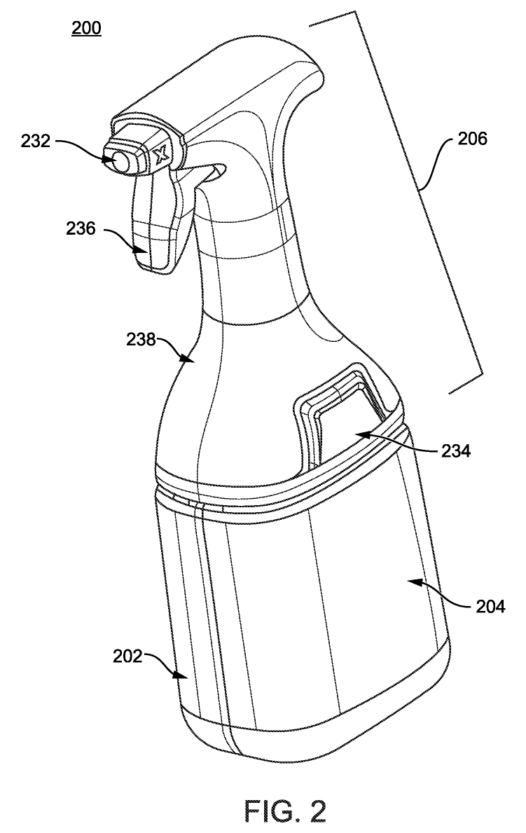

Various views and components of an exemplary implementation of the spray bottle 100 of FIG. 1 are provided in FIGS. 2-8. Like-named elements in FIGS. 1 and 2-8 are thus not all necessarily explained again in detail. As shown in FIG. 2, a spray bottle 200 can include a first liquid container 202, a second liquid container 204, and a spray head 206. The first liquid container 202 can be configured to contain a first liquid, and the second container 204 can be configured to contain a second liquid. The spray head 206 can be configured to releasably couple to the first liquid container 202 and the second liquid container 204 simultaneously or sequentially, as discussed herein.

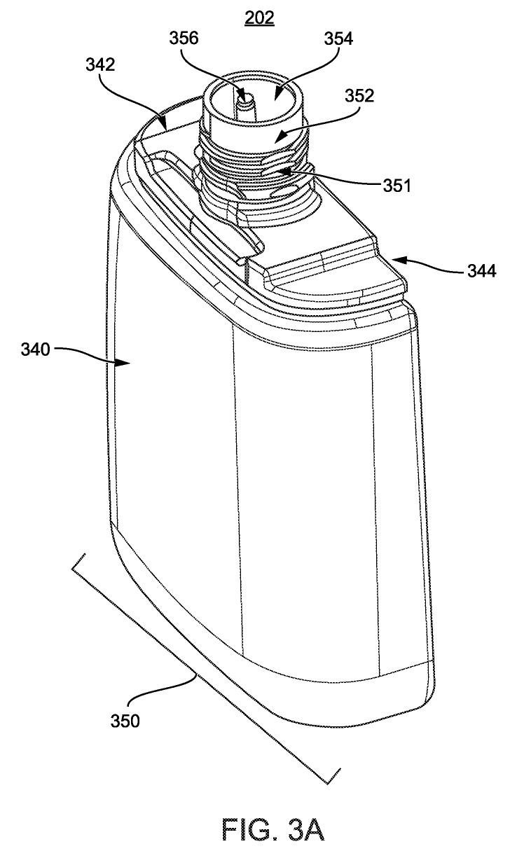

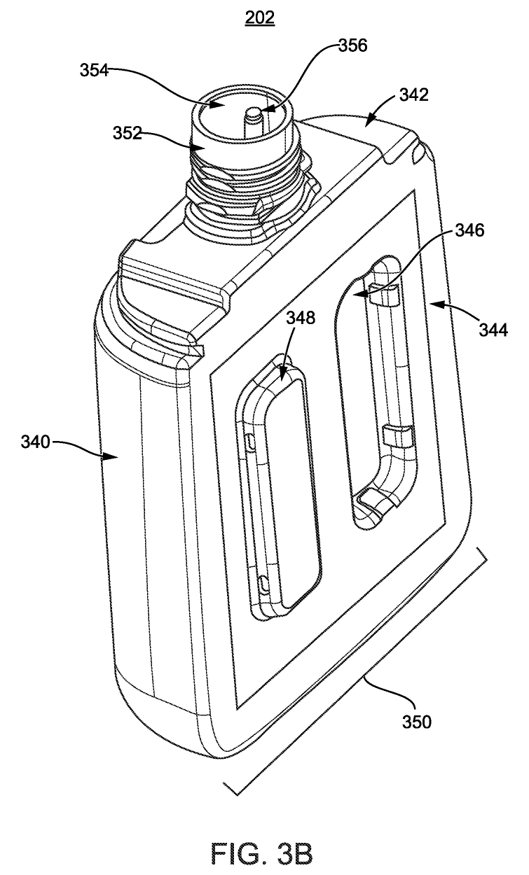

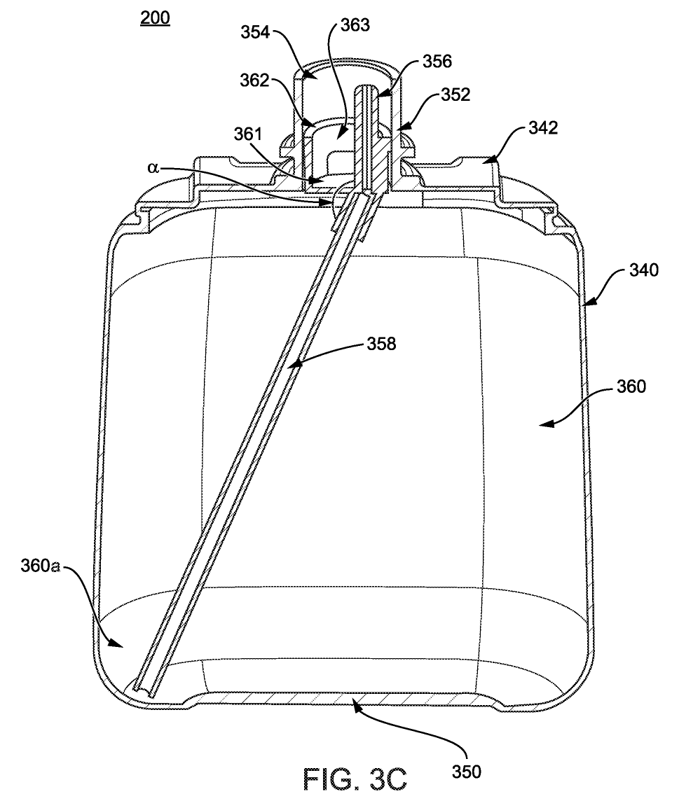

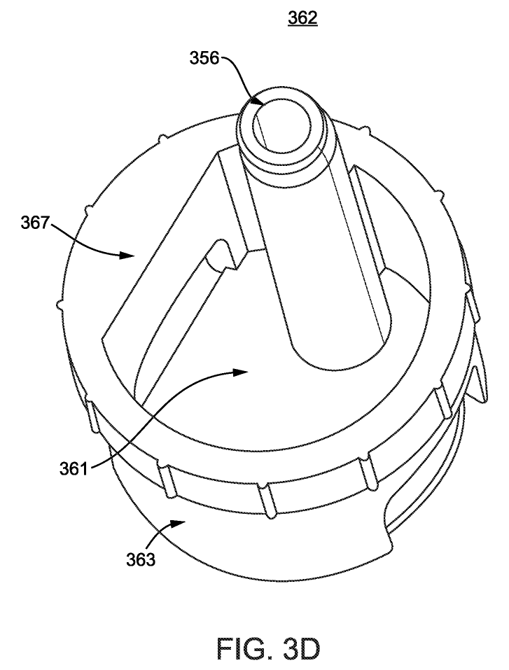

The first liquid container 202 is shown in isolation in FIGS. 3A-C. The second liquid container 204 can be an identical mirror of the first liquid container 202 and can include the same structural features as the first liquid container 202. Since the first and second liquid containers 202, 204 can include the same structural features, only those of the first liquid container 202 are shown and described in detail herein. The second liquid container 204 can be assumed to include the same features as the first liquid container 202.

As shown in FIGS. 3A-B, the first liquid container 202 can include an outer side surface 340, an upper surface 342 having a neck 352 protruding therefrom, an inner side surface 344, and a bottom surface 350. The surfaces 340, 342, 344, 350 of the first liquid container 202 can together define an interior volume 360 (FIG. 3C) that is configured to contain the first liquid.

The outer side surface 340 can be a convex curved surface that extends from one side edge of the inner side surface 344 to the opposite side edge of the inner side surface, as shown in FIG. 3A. The outer side surface 340 can be curved to increase the interior volume 360 of the first liquid container 202.

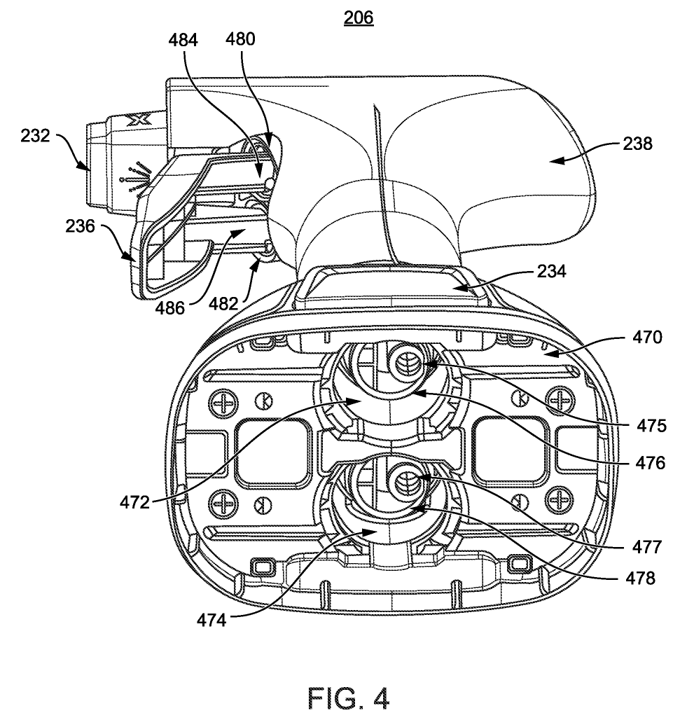

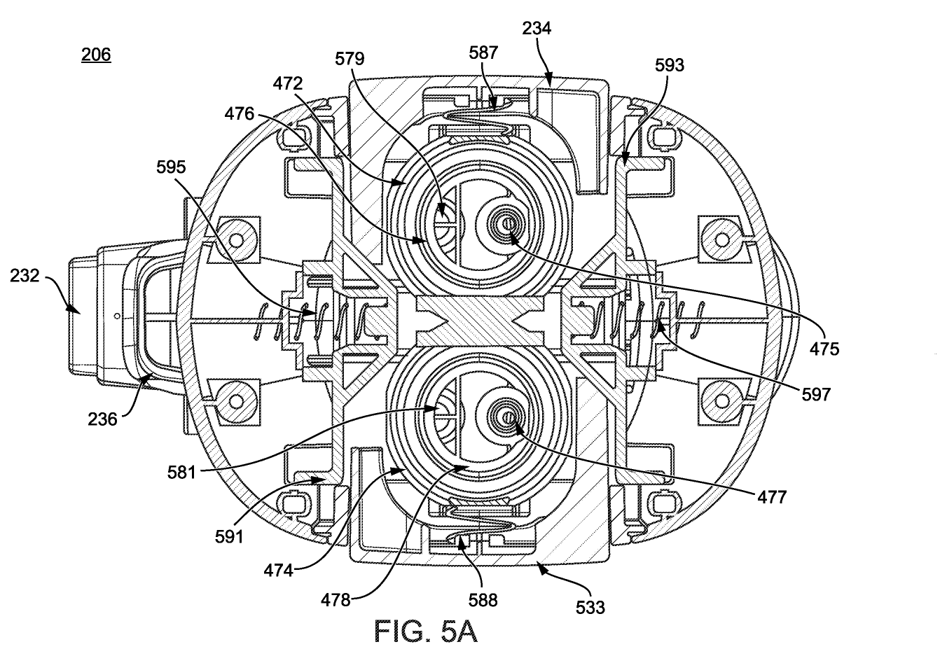

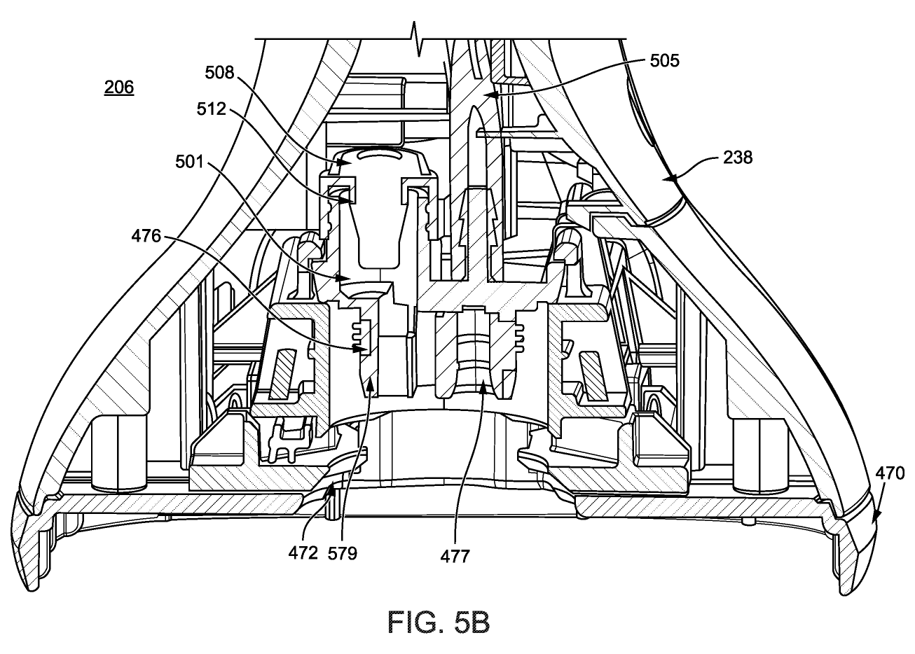

As explained in further detail below with respect to FIGS. 4 and 5A-B, the upper surface 342 and the neck 352 can be configured to mate with the spray head 206 to releasably couple the first liquid container 202 to the spray head 206.

As shown in FIG. 2, with the first and second liquid containers 202, 204 coupled to the spray head 206, the first and second liquid containers 202, 204 can be in flush contact with one another. To enable such flush positioning, the inner side surface 344 of the first liquid container 202 can be substantially flat (FIG. 3B). The inner side surface 344 can include an indent 346 and a protrusion 348. The indent 346 and the protrusion 348 can be configured to mate with a protrusion and an indent, respectively, on an inner side surface of the second liquid container 204 to restrict movement of the first and second liquid containers 202, 204 relative to one another with the first and second liquid containers 202, 204 coupled to the spray head 206. The mated protrusion/indent pairs may facilitate simultaneous coupling of the first and second liquid containers 202, 204 to the spray head 206 and simultaneous de-coupling of the first and second liquid containers 202, 204 from the spray head 206 by restricting movement of the first and second liquid containers 202, 204 relative to one another. The first and second liquid containers 202, 204 have two mated protrusion/indent pairs in this illustrated implementation but another number may be used, one pair, three pairs, etc.

An opening 354 into the interior volume 360 of the first liquid container 202 can extend through the neck 352. A plug 362 (FIG. 3C) can be disposed within the opening 354. The plug 362 can include a flat bottom surface 361, a sidewall 363 extending from an edge of the bottom surface 361, and a tube (also referred to herein as a “plug tube”) 356 passes through the bottom surface 361. The sidewall 363 can extend at least partially along an inner surface of the neck 352, and the bottom surface 361 can extend at least partially across the opening 354. Above the bottom surface 361 (that is, on the side of the bottom surface 361 that faces out of the first liquid container 202), the tube 356 can extend parallel to the neck 352 and approximately perpendicular to the bottom surface 361. Below the bottom surface 361 (that is, on the side of the bottom surface 361 that faces into the first liquid container 202), the tube 356 can extend at an angle α with respect to the neck 352. The angle α can be between approximately 90° and approximately 180°, for example approximately 115°, approximately 125°, approximately 135°, approximately 145°, or approximately 165°. For example, the angle α can be approximately 158°, e.g., 157.6°, 157.7°, 157.8°, 157.9°, 158.1°, 158.2°, 158.3°, 158.4°, or 158.5°.

FIG. 3D shows an isolated view of the plug 362. As shown, a top of the plug 362 can be asymmetric and can include a flat surface 367. The asymmetry resulting from the presence of the flat surface 367 can prevent the first liquid container 202 from being coupled to the spray head 206 in an incorrect orientation, thereby preventing the first liquid contained in the first liquid container 202 from interacting with components of the spray head 206 that are intended to interact with the second liquid in the second liquid container 204.

A dip tube 358 can be inserted into and fixedly attached, e.g., by press fit, to the portion of the plug tube 356 that is below the bottom surface 361 of the plug 362. The dip tube 358 and the plug tube 356 can together form a tube that is configured to transmit liquid contained in the interior volume 360 out of the first liquid container 202 through the opening 354. The plug tube 356 can hold the dip tube 358 at the angle αwith respect to the neck 352 such that the dip tube 358 extends from the plug tube 356 to a corner portion 360a of the interior volume 360 defined by the outer surface 340 and the bottom surface 350. The angled orientation of the dip tube 358 can enable the dip tube 358 to access first liquid in the deepest portions of the interior volume 360 (that is, the portions of the interior volume 360 that are farthest from the opening 354), thereby allowing first liquid container 202 to be fully or nearly fully emptied of liquid by entering into the dip tube 358.

The dip tube 358 and the plug 362 can be assembled outside of the first liquid container 202 and subsequently press-fit into the opening 354. That is, the dip tube 358 can be inserted into the plug tube 356 and then the connected dip tube 358 and plug 362 can be pressed into the opening 354.

In some implementations, the first liquid container 202 can be provided separately from the spray head 206 and can be configured to be coupled to the spray head 206 by a user. For example, the first liquid container 202 can be provided as a replacement for a container, which can be identical to the first liquid container 202, that was emptied of the first liquid. In some implementations, the first liquid container 202 and the second liquid container 204 can be provided as a set (e.g., bound together with shrink wrap and/or otherwise fixed together) and can be configured to be simultaneously coupled to the spray head 206 by a user to replace a pair of containers, which can be identical to the first and second liquid container 202, 204, that were emptied of the first and second liquids.

The first liquid container 202 can be provided filled with the first liquid, with the dip tube 358 and the plug 362 press-fit into the opening 354, and with the opening 354 sealed by a disposable cap (not shown). As shown in FIG. 3A, the neck 352 can have a threaded lower surface 351 configured to mate with corresponding threads on the disposable cap. Providing the first liquid container 202 filled with the first liquid and with the dip tube 358 integrated within the interior volume 360 can reduce user assembly requirements and prevent accidental contact between the first liquid contained in the first liquid container 202 and components of the spray bottle 200 that are intended to interact with the second liquid in the second liquid container 204. Referring again to FIG. 2, the spray head 206 can include a housing 238, a first button 234 arranged on a first side of the housing 238, a trigger 236, and an outlet 232. The outlet 232 is a nozzle in this illustrated implementation and is also referred to herein as an outlet nozzle 232. Isolated views of the spray head 206 are provided in FIGS. 5A-8. As shown in FIG. 5A, a second button 533 can be arranged on a second side of the housing 238 opposite the first button 234. A first cavity 472 and a second cavity 474 can extend through a bottom portion 470 of the spray head 206. A first fluid tube 505 and a second fluid tube 607 can respectively extend within the housing 238 between the cavities 472, 474 and the outlet nozzle 232.

As described, the spray head 206 can be configured to releasably couple to the first and second liquid containers 202, 204. The cavities 472, 474 can be configured to receive the necks of the first and second liquid containers 202, 204, respectively (the neck 352 of the first liquid container 202 is shown in FIGS. 3A-C).

As shown in FIG. 5A, the first button 234 can be mechanically coupled to a first spring 587 and to a first spring-loaded latch 591 having a second spring 595. Similarly, the second button 533 can be mechanically coupled to a third spring 588 and a second spring-loaded latch 593 having a fourth spring 597. Pressing the first button 234 can compress the spring 587 to move the first button 234 toward the interior of the spray head 206 and can cause the first button 234 to act as a slider arm that actuates the first spring-loaded latch 591 such that the first liquid container 202 can be inserted into the cavity 472. When the first liquid container 202 is inserted into the cavity 472 and the first button 234 is released, the first spring 587 can return the first button 234 to its original position and the second spring 595 can force the first spring-loaded latch 591 to engage with the neck 352 of the first liquid container 202 to retain the first liquid container 202 in the cavity 472. Likewise, pressing the second button 533 can compress the third spring 588 to move the second button 533 toward the interior of the spray head 206 and can cause the second button 533 to act as a slider arm that actuates the second spring-loaded latch 593 such that the second liquid container 204 can be inserted into the cavity 474. When the second liquid container 204 is inserted into the cavity 474 and the second button 533 is released, the third spring 588 can return the second button 533 to its original position and the fourth spring 597 can force the second spring-loaded latch 593 to engage with the neck of the second liquid container 204 to retain the second liquid container 204 in the cavity 474.

As shown in FIGS. 4 and 5A, a first fluid inlet manifold 476 can be arranged in the first cavity 472 and a second fluid inlet manifold 478 can be arranged in the second cavity 474. The first fluid inlet manifold 476 can define a first liquid inlet 475, and the second fluid inlet manifold 478 can define a second liquid inlet 477. When the first liquid container 202 is inserted into the first cavity 472, the plug tube 356 (see FIGS. 3C-D) can fluidically couple to the first liquid inlet 475. Likewise, when the second liquid container 204 is inserted into the second cavity 476, the plug tube arranged in the opening of the second liquid container 204 can fluidically couple to the second liquid inlet 477.

A cross-sectional side view of the first fluid inlet manifold 476 is provided in FIG. 5B. The second fluid inlet manifold 478 can be substantially similar to the first fluid inlet manifold 476 and will not be described in detail. However, the second fluid inlet manifold 478 can be assumed to include the same features as the first fluid inlet manifold 476.

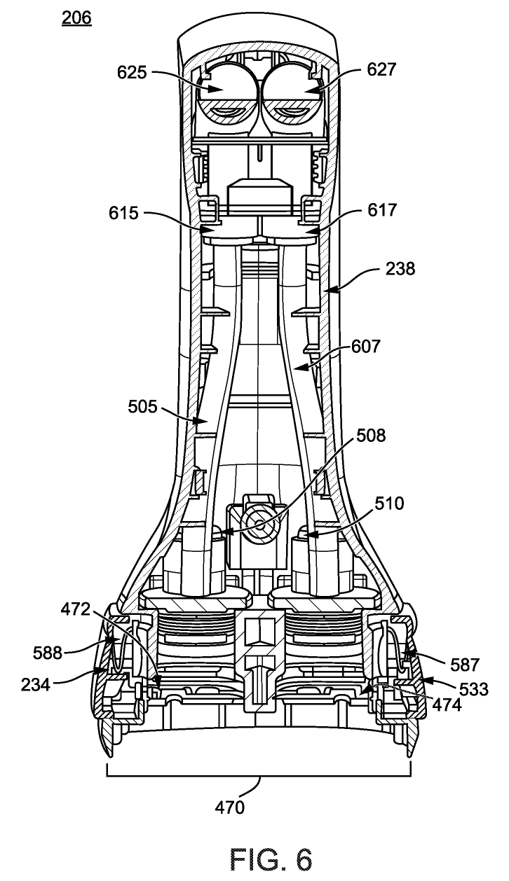

As shown in FIG. 5B, the first liquid inlet 475 defined by the first fluid inlet manifold 476 can extend into a first liquid tube 505. The first liquid tube 505 can be similar to the first fluid pathway 105 shown in FIG. 1. The second liquid inlet 477 defined by the second fluid inlet manifold 478 can likewise extend into a second liquid tube 607. The second liquid tube 607 is illustrated in FIG. 6 and can be similar to the second fluid pathway 107 shown in FIG. 1.

In addition to the first liquid inlet 475, the first fluid inlet manifold 476 can define a first gas inlet 579 (FIG. 5B). The first gas inlet 579 can lead into a first gas chamber 501. The first gas chamber 501 can be similar to the first gas pathway 101 shown in FIG. 1. The first gas chamber 501 can lead to a first gas outlet 512, which can be similar to the first gas outlet 112 shown in FIG. 1. A first gas valve 508, similar to the first gas valve 108 shown in FIG. 1, can be arranged in the first gas outlet 512. In the illustrated implementation, the first gas valve 508 is a duckbill valve.

When the first liquid container 202 is inserted into the first cavity 472, the plug tube 356 (see FIGS. 3C-3D) can fluidically couple to the first gas inlet 579. This fluidic coupling can allow gas that is produced in the first liquid container 202 (e.g., as a byproduct of a chemical reaction involving the first liquid contained in the first liquid container 202) to flow out of the first liquid container 202 through the plug tube 356 and into the first gas chamber 501. As gas fills the first gas chamber 501, the pressure within the first gas chamber 501 will increase. The first gas valve 508 can be configured to open to enable the gas contained in the first gas chamber 501 to vent through the first gas outlet 512 when the pressure in the first gas chamber 501 exceeds a threshold pressure level. With the first gas valve 508 open, the pressure in the first gas chamber 501 will decrease. The first gas valve 508 will close again when the pressure in the first gas chamber 508 falls below the threshold pressure level. Gas that is released through the first gas valve 508 can dissipate into the environment surrounding the spray bottle 200 through the housing 238 of the spray head 206.

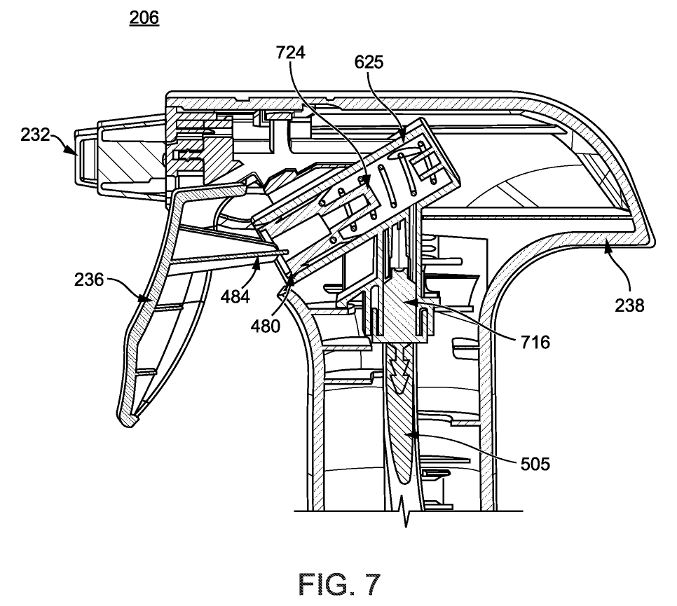

As shown in FIG. 6, the first and second liquid tubes 505, 607 can extend, respectively, from the first and second liquid inlets 475, 477, through the interior region of the spray head 206. The first liquid tube 505 can lead to a first liquid valve 716 contained within an enclosure 615 (FIGS. 6-7). The first liquid valve 716 can be similar to the first liquid valve 116 shown in FIG. 1. Similarly, the second liquid tube 607 can lead to a liquid valve (not shown) contained within a second enclosure 617 (FIG. 6). The liquid valve contained in the second enclosure 617 can be similar to the third liquid valve 118 shown in FIG. 1.

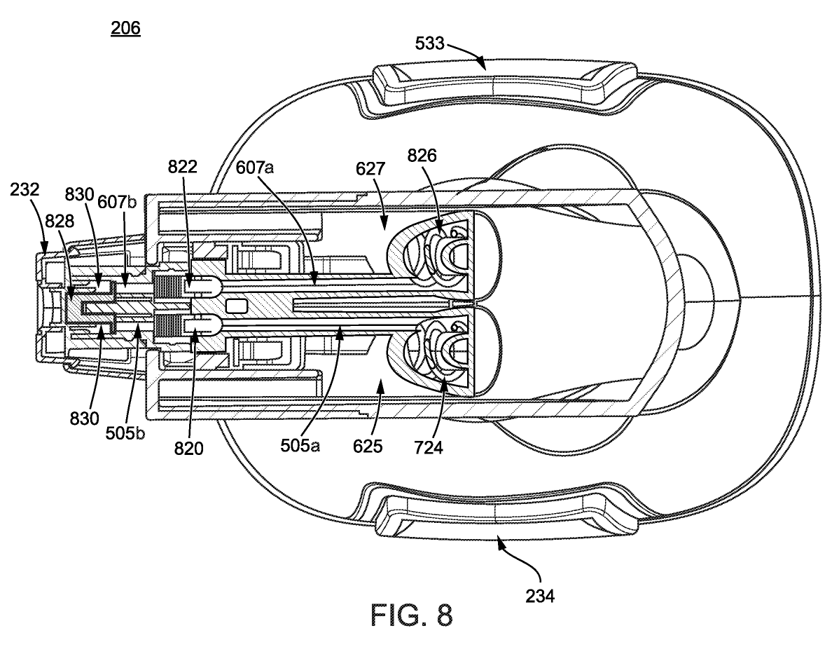

As shown in FIG. 8, downstream of the first liquid valve 716 can be a second liquid valve 820. The second liquid valve 820 can be similar to the second liquid valve 120 shown in FIG. 1. The first and second liquid valves 716, 820 can together divide the region of the first liquid tube 505 that is downstream of the first liquid valve 716 into a first region 505a between the first liquid valve 716 and the second liquid valve 820 and a second region 505b downstream of the second liquid valve 820. Similarly, downstream of the valve arranged in the second liquid tube 607 that is contained in the second enclosure 617 can be a liquid valve 822. The liquid valve 822 can be similar to the fourth liquid valve 122 shown in FIG. 1. The liquid valve contained in the second enclosure 617 and the liquid valve 822 can together divide the region of the second liquid tube 607 that is downstream of the liquid valve contained in the second enclosure 716 into a first region 607a between the liquid valve contained in the enclosure 617 and the liquid valve 822 and a second region 607b downstream of the liquid valve 822.

A mixing chamber 830 can be arranged downstream of the second region 505b of the first liquid tube 505 and of the second region 607b of the second liquid tube 607. The mixing chamber 830 can be similar to the mixing chamber 130 shown in FIG. 1. As shown in FIG. 8, the mixing chamber 830 can be arranged just upstream of the outlet nozzle 232. A valve 828 can separate the regions 505b, 607b from the mixing chamber 830.

As shown in FIG. 6, the spray head 206 can include a pair of enclosures 625, 627. As shown in FIG. 7, the first enclosure 625 can house a first piston 724. The first piston 724 can be similar to the first piston 124 shown in FIG. 1. The second enclosure 627 can likewise house a second piston (not shown) that is similar to the second piston 126 shown in FIG. 1.

Each of the first piston 724 and the second piston can be configured to move longitudinally within its respective enclosure 625, 627 from a first position to a second position and from the second position to the first position. The first piston 724 and the second piston can be actuated simultaneously by the trigger 236. As shown in FIG. 4, a pair of arms 484, 486 can extend from the trigger 236 and through a pair of holes 480, 482 in the housing 238 of the spray head 206. As shown in FIG. 7, inside the housing 238, the first arm 484 can contact the first piston 724. The second arm 486 can likewise contact the second piston. The trigger 236 can be configured to move from a first position (e.g., the position illustrated in FIGS. 2, 4 and 7) to a second position (e.g., a second position closer to the housing 238 of the spray head 206). The movement of the trigger 236 from the first position to the second position can push the first and second arms 484, 486 through the holes 480, 482, respectively, thereby causing the first arm 484 to move the first piston 724 from its first position to its second position and causing the second arm 486 to move the second piston from its first position to its second position. Once in its second position, the trigger 236 can be configured to move back automatically to its first position, when a user releases pressure on the trigger 236, to retract the first and second arms 484, 486 through the holes 480, 482, respectively. As the first arm 484 retracts, the first piston 724 can move from its second position to its first position. Similarly, as the second arm 486 retracts, the second piston can move from its second position to its first position.

The movement of the first piston 724 and the second piston from their first positions to their second positions can generate first pressure changes in the first liquid tube 505 and the second liquid tube 607, respectively. The movement of the first piston 724 and the second piston from their second positions to their first positions can generate second pressure changes in the first liquid tube 505 and the second liquid tube 607, respectively.

As a result of the first pressure change in the first liquid tube 505, the first liquid contained in the first liquid container 202 can be drawn into the first liquid tube 505. The first liquid valve 716 can be configured to be opened by the first pressure change such that, when the first liquid enters the first liquid tube 505, the first liquid is drawn into the first region 505a of the first liquid tube 505. The second liquid valve 820 can be configured to be closed by the first pressure change so that the first liquid that is drawn into the first region 505a does not flow into the second region 505b of the first liquid tube 505. Similarly, as a result of the first pressure change in the second liquid tube 607, the second liquid contained in the second liquid container 204 can be drawn into the second liquid tube 607. The liquid valve contained in the enclosure 617 can be configured to be opened by the first pressure change such that, when the second liquid enters the second liquid tube 607, the second liquid is drawn into the first region 607a of the second liquid tube 607. The liquid valve 822 can be configured to be closed by the first pressure change so that the second liquid that is drawn into the second region 607a does not flow into the second region 607b of the second liquid tube 607.

As a result of the second pressure change in the first liquid tube 505, the first liquid valve 716 can be configured to be closed and the second liquid valve 820 can be configured to be opened. When the second liquid valve 820 is opened by the second pressure change, the first liquid that is contained in the first region 505a of the first liquid tube 505 can flow into the second region 505b of the first liquid tube 505. Similarly, as a result of the second pressure change in the second liquid tube 607, the liquid valve contained in the enclosure 617 can be configured to be closed and the liquid valve 822 can be configured to be opened. When the liquid valve 822 is opened by the second pressure change, the second liquid that is contained in the first region 607a of the second liquid tube 607 can flow into the second region 607b of the second liquid tube 607.

The valve 828 that separates the regions 505b, 607b from the mixing chamber 830 can be configured to be opened by the first pressure changes in the first and second liquid tubes 505, 507. When the valve 828 opens, the mixing chamber 830 fluidically couples to the first liquid tube 505 and the second liquid tube 607 such that the first liquid that is contained in the second region 505b of the first liquid tube 505 and the second liquid that is contained in the second region 607b of the second liquid tube 607 enters the mixing chamber 830 to form a mixture of the first liquid and the second liquid. Since the liquid valves 820, 822 are configured to be closed by the first pressure changes, the mixture of the first liquid and the second liquid is prevented from backflowing into the first and second liquid tubes 505, 607.

The first pressure changes in the first and second liquid tubes 505, 607 can further be configured to allow liquid in the mixing chamber 830 to move through the outlet nozzle 238. Accordingly, as a result of the first pressure changes, the first liquid and the second liquid can enter the mixing chamber 830, mix to form the mixture of the first and second liquids, and be ejected through the outlet nozzle 238. By simultaneously mixing the first and second liquids and ejecting the mixture, the spray head 206 may significantly limit the amount of time that the mixture is retained within the spray bottle 200 without being used, thereby increasing the potency and effectiveness of the mixture that is dispensed.

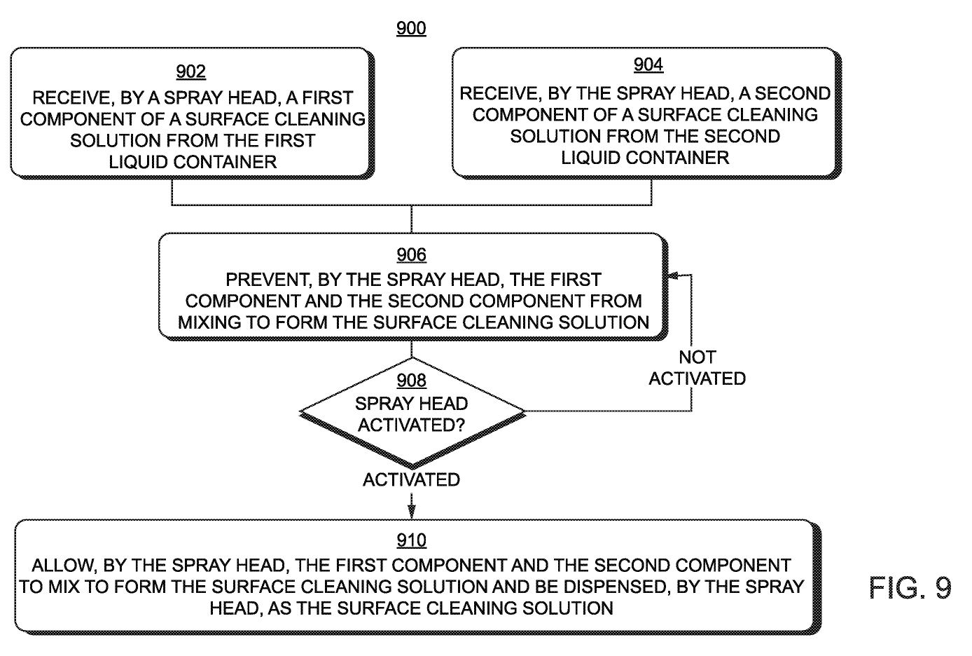

FIG. 9 is a flowchart illustrating an exemplary method 900 of operating a spray bottle. The method 900 of FIG. 9 can be executed by a spray bottle such as the spray bottle system 100 shown in FIG. 1 or the spray bottle 200 shown in FIGS. 2-8. In general, the method 900 can enable two liquids to be mixed on-board the spray head (e.g., the spray head 106 of the spray bottle system 100, the spray head 206 of the spray bottle 200, etc.) to form a solution. The method 900 of FIG. 9 is described with respect to a surface cleaning solution but can be similarly performed for another type of solution.

The method 900 of FIG. 9 is intended only as an example implementation of a method of operating a spray bottle. Those skilled in the art will appreciate that, in some implementations, a method of operating a spray bottle can be executed in a different order than the method 900 of FIG. 9. Additionally, in some implementations, a method of operating a spray bottle can include portions that are not included in the method 900 of FIG. 9, and in some implementations, a method of operating a spray bottle can omit portions that are included in the method 900 of FIG. 9.

At 902, a first component (also referred to herein as a “first liquid component”) of a surface cleaning solution can be received by a spray head of the spray bottle from a first liquid container (e.g., the first liquid container 102 of the spray bottle system 100, the first liquid container 202 of the spray bottle 200, etc.). At 904, a second component (also referred to herein as a “second liquid component”) of the surface cleaning solution can be received by the spray head from a second liquid container (e.g., the second liquid container 104 of the spray bottle system 100, the second liquid container 204 of the spray bottle 200, etc.).

When the first liquid component and the second liquid component of the surface cleaning solution are received by the spray head, the first and second liquid components can be prevented, at 906, by the spray head, from mixing to form the surface cleaning solution. The spray head can prevent the first and second liquid components from mixing to form the surface cleaning solution until the spray head is activated (908). In some implementations, the spray head can include a trigger (e.g., the trigger 238 of the spray bottle 200, etc.) configured to be pulled by a user to activate the spray head. Once activated, the spray head can allow the first and second liquid components of the surface cleaning solution to mix to form the surface cleaning solution and be dispensed as the mixture from the surface cleaning solution (910).

In some implementations, activating the spray head at 908 opens a first seal or a valve (e.g., the valve 128 of the system 100, the valve 828 of the spray bottle 200, etc.) which, in an open position, is configured to allow the first and second liquid components to mix within the spray head. The spray head can also include a second seal or valve upstream of the first seal and in a first liquid pathway associated with the first liquid container (e.g., the valve 120 of the system 100, the valve 820 of the spray bottle 200, etc.), a third valve or seal upstream of the first seal and in a second liquid pathway associated with the second liquid container (e.g., the valve 122 of the system 100, the valve 822 of the spray bottle 200, etc.), a fourth valve or seal upstream of the second seal and in the first liquid pathway associated with the first liquid container (e.g., the valve 116 of the system 100, the valve 716 of the spray bottle 200, etc.), a fifth valve or seal upstream of the third seal and in the second liquid pathway associated with the second liquid container (e.g., the valve 118 of the system 100, the valve contained in the enclosure 617 of the spray bottle 200, etc.), or a combination thereof. Activating the spray head at 908 can cause the second and third seals to open and to cause the first seal to open after the second and third seals open.

In some implementations, following activation at 908, the spray head can be deactivated. Deactivation of the spray head can be configured to cause the fourth and fifth seals to open after the first seal opens. If the spray head includes a trigger configured to activate the spray head 908 when pulled by a user, the trigger can be configured to deactivate the spray head 908 when released by the user.

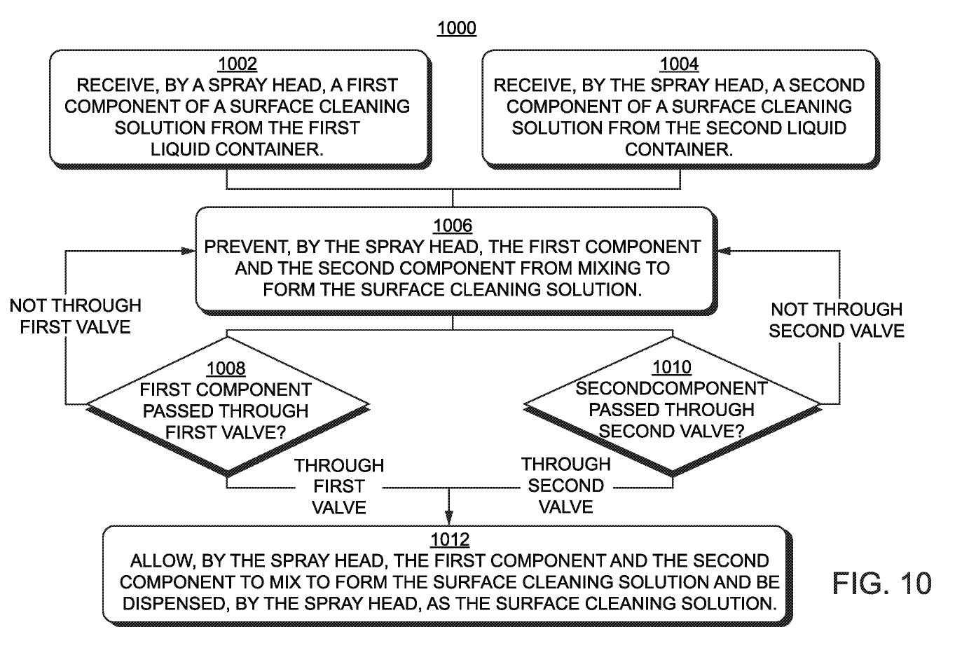

FIG. 10 is a flowchart illustrating another exemplary method 1000 of operating a spray bottle. The method 100 of FIG. 10 can be executed by a spray bottle such as the spray bottle system 100 shown in FIG. 1 or the spray bottle 200 shown in FIGS. 2-8. In general, the method 1000 can enable two liquids to be mixed on-board the spray head (e.g., the spray head 106 of the spray bottle system 100, the spray head 206 of the spray bottle 200, etc.) to form a solution. The method 1000 of FIG. 10 is described with respect to a surface cleaning solution but can be similarly performed for another type of solution.

The method 1000 of FIG. 10 is intended only as an example implementation of a method of operating a spray bottle. Those skilled in the art will appreciate that, in some implementations, a method of operating a spray bottle can be executed in a different order than the method 1000 of FIG. 10. Additionally, in some implementations, a method of operating a spray bottle can include portions that are not included in the method 1000 of FIG. 10, and in some implementations, a method of operating a spray bottle can omit portions that are included in the method 1000 of FIG. 10.

At 1002, a first component (also referred to herein as a “first liquid component”) of a surface cleaning solution can be received by a spray head of the spray bottle from a first liquid container (e.g., the first liquid container 102 of the spray bottle system 100, the first liquid container 202 of the spray bottle 200, etc.). At 1004, a second component (also referred to herein as a “second liquid component”) of the surface cleaning solution can be received by the spray head from a second liquid container (e.g., the second liquid container 104 of the spray bottle system 100, the second liquid container 204 of the spray bottle 200, etc.).

In some implementations, the first container has a first breathing valve (e.g., the first gas valve 108 of the system 100, the gas valve 508 of the spray bottle 200, etc.) configured to allow venting of the first container with the second seal in the closed position. The first breathing valve can include a duckbill valve. In some implementations, the first container has a vented liner configured to allow venting of the first container with the second seal in the closed position.

When the first component and the second component of the surface cleaning solution are received by the spray head, the first and second components can be prevented, at 1006, by the spray head, from mixing to form the surface cleaning solution. The spray head can prevent the first and second components from mixing to form the surface cleaning solution until the first component passes through a first seal or valve in the spray head (e.g., the valve 120 of the system 100, the valve 820 of the spray bottle 200, etc.) upstream of an outlet of the spray head (1008) and the second component passes through a second seal or valve in the spray head (e.g., the valve 122 of the system 100, the valve 822 of the spray bottle 200, etc.) upstream of the outlet of the spray head (1010). When the first component has passed through the first seal or valve and the second component has passed through the second seal or valve, the spray head can allow the first and second components of the surface cleaning solution to mix to form the surface cleaning solution and be dispensed as the surface cleaning solution (1012).

In some implementations, the spray head includes a valve or seal (e.g., the valve 128 of the system 100, the valve 828 of the spray bottle 200) upstream of the outlet, downstream of the first and second one-way valves, and downstream of the mixing chamber. In an open position, this seal can be configured to allow the first and second components to enter the mixing chamber. In a closed position, this seal can be configured to prevent the first and second components from entering the mixing chamber.

In some implementations, the spray head includes a valve or seal (e.g., the valve 116 of the system 100, the valve 716 of the spray bottle 200, etc.) upstream of the first valve or seal which, in an open position, is configured to allow the first component to flow toward the first one-way valve, and in a closed position, is configured to prevent the first component from flowing toward the first valve or seal. In some implementations, the spray head includes a valve or seal upstream of the second valve or seal (e.g., the valve 118 of the system 100, the valve contained in the enclosure 617 of the spray bottle 200, etc.) which, in an open position, is configured to allow the second component to flow toward the second one-way valve, and, in a closed position, is configured to prevent the second component from flowing toward the second one-way valve.

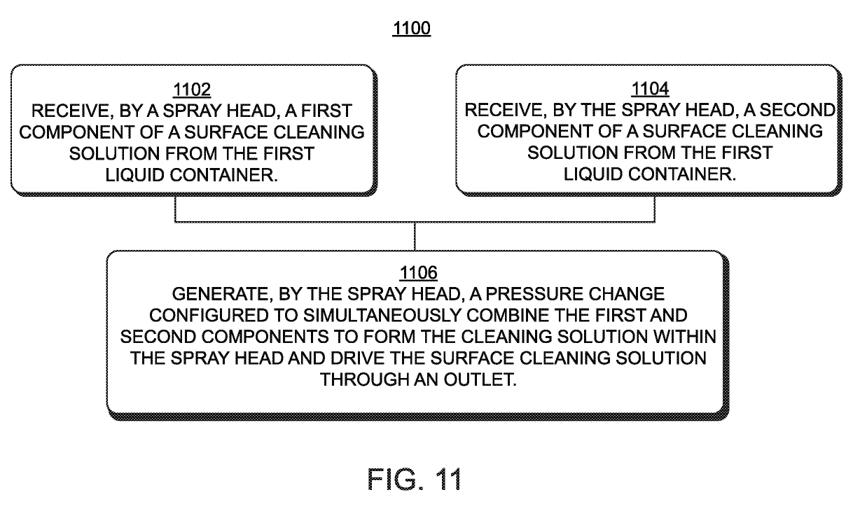

FIG. 11 is a flowchart illustrating another exemplary method 1100 of operating a spray bottle. The method 1100 of FIG. 11 can be executed by a spray bottle such as the spray bottle system 100 shown in FIG. 1 or the spray bottle 200 shown in FIGS. 2-8. In general, the method 1100 can enable two liquids to be mixed on-board the spray head (e.g., the spray head 106 of the spray bottle system 100, the spray head 206 of the spray bottle 200, etc.) to form a solution. The method 1100 of FIG. 11 is described with respect to a surface cleaning solution but can be similarly performed for another type of solution.

The method 1100 of FIG. 11 is intended only as an example implementation of a method of operating a spray bottle. Those skilled in the art will appreciate that, in some implementations, a method of operating a spray bottle can be executed in a different order than the method 1100 of FIG. 11. Additionally, in some implementations, a method of operating a spray bottle can include portions that are not included in the method 1100 of FIG. 11, and in some implementations, a method of operating a spray bottle can omit portions that are included in the method 1100 of FIG. 11.

At 1102, a first component (also referred to herein as a “first liquid component”) of a surface cleaning solution can be received by a spray head of the spray bottle from a first liquid container (e.g., the first liquid container 102 of the spray bottle system 100, the first liquid container 202 of the spray bottle 200, etc.). At 1104, a second component (also referred to herein as a “second liquid component”) of the surface cleaning solution can be received by the spray head from a second liquid container (e.g., the second liquid container 104 of the spray bottle system 100, the second liquid container 204 of the spray bottle 200, etc.). At 1106, the spray head can generate a pressure change configured to simultaneously combine the first and second components to form the cleaning solution within the spray head and drive the surface cleaning solution through an outlet of the spray head.

In some implementations, the spray head includes a first region upstream of the outlet (e.g., the first liquid pathway 105 of the system 100, the first liquid tube 505 of the spray bottle 200, etc.) and a second region upstream of the outlet (e.g., the second liquid pathway 107 of the system 100, the second liquid tube 607 of the spray bottle 200, etc.). The spray head can be configured to receive the first component of the surface cleaning solution in the first region and receive the second component of the surface cleaning solution in the second region. The spray head can also include a third region downstream of the first and second regions and upstream of the outlet (e.g., the third liquid pathway 109 of the system 100, the mixing chamber 830 of the spray bottle 200, etc.). The third region can be configured to selectively fluidically couple to the first and second regions. The generated pressure change can be configured to fluidically couple the third region to the first and second regions, e.g., by opening a valve (e.g., the valve 128 of the system 100, the valve 838 of the spray bottle 200, etc.) arranged at a junction of the third region and the first and second regions.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

1. A system comprising:
a first liquid pathway;
a second liquid pathway fluidically isolated from the first liquid pathway;
a third liquid pathway arranged downstream of the first liquid pathway and the second liquid pathway and configured to selectively fluidically couple to the first liquid pathway and the second liquid pathway;
an outlet arranged downstream of the third liquid pathway; and
a trigger configured to move from a first position to a second position and thereby simultaneously fluidically couple the third liquid pathway to the first liquid pathway and the second liquid pathway and allow liquid that enters the third liquid pathway from the first and second liquid pathways to move through the outlet.

2. The system of claim 1, further comprising a valve arranged at a junction of the third liquid pathway with the first and second liquid pathways,
wherein movement of the trigger between the first position and the second position opens the valve.

3. The system of claim 2, wherein the valve is a flap valve.

4. The system of claim 1, wherein a volume of the third liquid pathway is less than 0.5 mL.

5. The system of claim 1, wherein the first liquid pathway is configured to fluidically couple to a first liquid container and the second liquid pathway is configured to fluidically couple to a second liquid container.

6. The system of claim 5, wherein the first liquid container is configured to contain a first liquid and the second liquid container is configured to contain a second liquid.

7. The system of claim 6, further comprising the first and second liquid containers;
wherein the first liquid container is configured to be releasably coupled to the spray head; and
the second liquid container is configured to be releasably coupled to the spray head independent of the first liquid container.

8. The system of claim 6, wherein, with the third liquid pathway fluidically coupled to the first and second liquid pathways, the first liquid is configured to enter the third liquid pathway from the first liquid pathway and the second liquid is configured to enter the third liquid pathway from the second liquid pathway to form a mixture of the first and second fluids in the third liquid pathway.

9. The system of claim 8, wherein the mixture of the first liquid and the second liquid is unstable.

10. The system of claim 6, further comprising:
a first piston configured to draw the first liquid into the first liquid pathway; and
a second piston configured to draw second into the second liquid pathway.

11. The system of claim 10, wherein the first piston and the second piston are operatively mechanically coupled to the trigger.

12. The system of claim 1, wherein the first liquid container is configured to contain a first liquid that is a first component of a surface cleaning solution; and
the second liquid container is configured to contain a second liquid that is a second component of the surface cleaning solution.

13. The system of claim 12, wherein the first liquid pathway is fluidically isolated from the second liquid pathway until an area just upstream of the outlet within which the first and second fluids are configured to mix together.
